(19) United States
(12) Patent Application Publication
(10) Pub. No.: US 2023/0003124 A1
(43) Pub. Date: Jan. 5, 2023

(54) Method and System for Predicting Specific Energy of Cutter Head of Tunnel Boring Machine

(71) Applicant: Tianjin University, Tianjin (CN)

(72) Inventors: Qian Zhang, Tianjin (CN); Shanglin Liu, Tianjin (CN); Siyang Zhou, Tianjin (CN); Yilan Kang, Tianjin (CN); Zongxi Cai, Tianjin (CN)

(21) Appl. No.: 17/480,959

(22) Filed: Sep. 21, 2021

(30) Foreign Application Priority Data
Jun. 25, 2021 (CN) 202110711100.5

(51) Int. Cl. E21D 9/00; G06F 30/27

(52) U.S. Cl. CPC E21D 9/003; G06F 30/27; G06F 2111/10

(57) ABSTRACT

A method for predicting a specific energy of a cutter head of a tunnel boring machine includes obtaining a parameter of the tunnel boring machine to be measured configured to influence the specific energy of the cutter head to be measured, and inputting the obtained parameter of the tunnel boring machine to be measured into a model for predicting the specific energy of an apparatus to obtain a total predicted specific energy value of the cutter head and a proportion of each component of the total predicted specific energy value. The method comprehensively considers various influence factors, and outputs a proportion and a change of each component in the specific energy of the cutter head along with the construction process, thereby providing a foundation for optimal allocation of the specific energy of the cutter head of the tunnel boring machine.

### CROSS REFERENCE TO RELATED APPLICATION(S)

This patent application claims the benefit and priority of Chinese Patent Application No. 202110711100.5, filed on Jun. 25, 2021, the disclosure of which is incorporated by reference herein in its entirety as part of the present application.

### TECHNICAL FIELD

The present disclosure relates to the technical field of energy consumption prediction, in particular to a method and system for predicting specific energy of a cutter head of a tunnel boring machine.

### BACKGROUND

A tunnel boring machine (TBM) is a heavy-duty apparatus widely used in underground tunnel construction. It consumes huge energy for the tunnel boring machine to construct underground tunnel engineering. If the specific energy of the cutter head and the change of the specific energy can be effectively predicted in the tunnel boring process, it will be well-founded to trace and allocate the energy consumption of a control system, so as to save energy and reduce cost on the premise of lowering the construction safety risk. The state monitoring data of the tunnel boring machine contains vital information related to tunnel boring energy consumption. However, as numerous factors influencing the energy consumption of the apparatus have characteristics of time-varying and coupling relations, for example, the various underground geological environment features change along with the construction section, and uncertain multiple coupling relations exist between the operation state of the apparatus and the geological environment features, it is difficult to predict and model the tunnel boring energy consumption based on the state monitoring data. The specific energy of the cutter head is an essential index to describe the construction energy consumption and efficiency of the tunnel boring machine, which means the energy consumed to bore through rock mass of unit volume. The energy consumption includes friction resistance consumption, rock breaking consumption, surrounding rock stress overcoming consumption, etc., and only a part of energy is consumed in the effective rock breaking work of the cutter head. Although the total specific energy of the cutter head can be predicted in the prior art, the proportion of each component in the specific energy of the cutter head and the change of the proportion during geological change and tunnel boring speed change in the construction process are unpredictable, which are the basic information for optimally allocating the specific energy of the cutter head of the tunnel boring machine.

### SUMMARY

The objective of the present disclosure is to provide a method and system for predicting specific energy of a cutter head of a tunnel boring machine. Influence factors of geometric structures of an apparatus and a tunnel, an operation state of an apparatus, a geological environment feature, etc. are comprehensively considered, so as to provide a proportion of each component in the specific energy of the cutter head and a change of the proportion during a construction process, thereby providing a foundation for optimally allocating the specific energy of the cutter head of the tunnel boring machine.

To implement the above objectives, the present disclosure provides the following solutions:

A method for predicting specific energy of a cutter head of a tunnel boring machine includes:

obtaining parameters, influencing the specific energy of the cutter head to be measured, of the tunnel boring machine, where the parameters influencing the specific energy of the cutter head to be measured comprise a geological environment feature parameter, geometric structure parameters of an apparatus and a tunnel and an operation state parameter of the apparatus;

inputting the parameters, influencing the specific energy of the cutter head to be measured, of the tunnel boring machine into a model for predicting the specific energy of an apparatus to obtain a predicted value of the specific energy of the cutter head; and

calculating a proportion of a specific energy component according to the predicted value of the specific energy of the cutter head, the parameters, influencing the specific energy of the cutter head to be measured, of the tunnel boring machine, a weight and an expression of a dimensionless factor;

where a method for determining the model for predicting the specific energy of an apparatus includes:

determining the parameters, influencing the specific energy, of the tunnel boring machine and the parameter of the specific energy of the cutter head of the tunnel boring machine;

determining the expression of the dimensionless factor with a physical mapping relation according to the parameters, influencing the specific energy, of the tunnel boring machine and the parameter of the specific energy of the cutter head of the tunnel boring machine;

determining, according to a loss function and the expression of the dimensionless factor, an objective function for predicting the specific energy;

obtaining a data sample of the parameters, influencing the specific energy, of the tunnel boring machine for model training and a data sample of the parameter of the specific energy of the cutter head of the tunnel boring machine for model training;

substituting the data sample of the parameters, influencing the specific energy, of the tunnel boring machine for model training and the data sample of the specific energy of the cutter head of the tunnel boring machine for model training into the objective function, and optimizing the objective function to obtain the weight of the dimensionless factor; and

obtaining the model for predicting the specific energy of an apparatus according to the weight and the expression of the dimensionless factor.

Preferably, the determining the parameters, influencing the specific energy, of the tunnel boring machine and the parameter of the specific energy of the cutter head of the tunnel boring machine may include:

determining thrust, torque and a depth of penetration of the tunnel boring machine in the data sample of the specific energy of the cutter head of the tunnel boring machine for model training; and

calculating, according to the thrust, the torque and the depth, the specific energy of the cutter head of the tunnel boring machine in the data sample of the specific energy of the cutter head of the tunnel boring machine for model training.

Preferably, the geological environment feature parameters may include:
uniaxial compressive strength of a rock, a volumetric joint count, weak plane structure spacing, an intactness coefficient of the rock, a structural plane direction, a structural plane dip angle, an included angle between a structural plane and a tunnel axis, a maximum horizontal principal stress of a tunnel, a minimum horizontal principal stress of the tunnel and a maximum initial stress perpendicular to the tunnel axis;

the geometric structure parameters may include: a diameter of the cutter head of the tunnel boring machine and a tunnel burial depth; and

the operation state parameters may include: a tunnel boring speed of the tunnel boring machine, a rotation speed of the cutter head, a horizontal pressure of a support cylinder and a push pressure of a shield cylinder.

Preferably, the determining the expression of the dimensionless factor with a physical mapping relation according to the parameters, influencing the specific energy, of the tunnel boring machine and the parameter of the specific energy of the cutter head of the tunnel boring machine may include:

calculating an expression of a first factor according to the tunnel burial depth and the diameter of the cutter head;

calculating an expression of a second factor according to the tunnel boring speed, the diameter of the cutter head and the rotation speed of the cutter head;

calculating an expression of a specific energy factor according to the specific energy of the cutter head, the uniaxial compressive strength of the rock, the diameter of the cutter head and a calculated second factor;

calculating an expression of a third factor according to the volumetric joint count and the diameter of the cutter head;

calculating an expression of a fourth factor according to the weak plane structure spacing and the diameter of the cutter head;

calculating an expression of a fifth factor according to the intactness coefficient of the rock;

calculating an expression of a sixth factor according to the structural plane direction;

calculating an expression of a seventh factor according to the structural plane dip angle;

calculating an expression of an eighth factor according to the included angle between the structural plane and the tunnel axis;

calculating an expression of a ninth factor according to the maximum horizontal principal stress of the tunnel and the uniaxial compressive strength of the rock;

calculating an expression of a tenth factor according to the minimum horizontal principal stress of the tunnel and the uniaxial compressive strength of the rock;

calculating an expression of an eleventh factor according to the maximum initial stress perpendicular to the tunnel axis and the uniaxial compressive strength of the rock;

calculating an expression of a twelfth factor according to the horizontal pressure of the support cylinder and the uniaxial compressive strength of the rock; and

calculating an expression of a thirteenth factor according to the push pressure of the shield cylinder and the uniaxial compressive strength of the rock;

where the expression of the dimensionless factor may include the expression of the specific energy factor, the expression of the first factor, the expression of the second factor, the expression of the third factor, the expression of the fourth factor, the expression of the fifth factor, the expression of the sixth factor, the expression of the seventh factor, the expression of the eighth factor, the expression of the ninth factor, the expression of the tenth factor, the expression of the eleventh factor, the expression of the twelfth factor, and the expression of the thirteenth factor.

Preferably, the determining, according to a loss function and the expression of the dimensionless factor, an objective function for predicting the specific energy may include:

substituting the expression of the dimensionless factor into the loss function;

and adding parameter norm penalty into the loss function with the substituted expression of the dimensionless factor, to obtain the objective function.

Preferably, the optimizing the objective function to obtain the weight of the dimensionless factor may include:

determining a value of a hyper-parameter in the objective function according to a parameter debugging result in the data sample of the parameters, influencing the specific energy, of the tunnel boring machine for model training and the data sample of the specific energy of the cutter head of the tunnel boring machine for model training; and

substituting the value of the hyper-parameter into the objective function, and optimizing the objective function according to the data sample of the parameters, influencing the specific energy, of the tunnel boring machine for model training and the data sample of the specific energy of the cutter head of the tunnel boring machine for model training, to obtain the weight of the dimensionless factor.

Preferably, the proportion of the specific energy component is calculated according to:

$${P}_{i} = \frac{{σ}_{c} v {w}^{- 1} {D}^{2} \cdot {θ}_{i}^{*} \cdot {π}_{i}}{{E}_{c}^{*}} ;$$

where Pᵢ may be a proportion of an ith component in calculated total specific energy; σ_{c} may be the geological environment feature parameter; vw⁻¹ may be the operation state parameter; θᵢ* may be the weight; πᵢ may be an expression of an ith dimensionless factor; and E_{c}* may be a prediction result of the total specific energy of the cutter head of the tunnel boring machine, that is, the predicted value of the specific energy of the cutter head.

A system for predicting specific energy of a cutter head of a tunnel boring machine includes:

a model construction module used for determining a model for predicting the specific energy of an apparatus;

an obtaining module used for obtaining parameters influencing the specific energy of the cutter head to be measured, where the parameters influencing the specific energy of the cutter head to be measured include a geological environment feature parameter, geometric structure parameters of the apparatus and a tunnel and an operation state parameter of the apparatus;

a prediction module used for inputting the parameters, influencing the specific energy to be measured, of the tunnel boring machine into the model for predicting the specific energy of an apparatus, to obtain a predicted specific energy value; and

a component calculation module used for calculating a proportion of a specific energy component according to the predicted value of the specific energy of the cutter head, the parameters, influencing the specific energy of the cutter head to be measured, of the tunnel boring machine, a weight and an expression of a dimensionless factor;

where the model construction module specifically includes:

a determination unit used for determining the parameters, influencing the specific energy, of the tunnel boring machine and the parameter of the specific energy of the cutter head of the tunnel boring machine;

a physical relation calculation unit used for determining the expression of the dimensionless factor with a physical mapping relation according to the parameters, influencing the specific energy, of the tunnel boring machine and the parameter of the specific energy of the cutter head of the tunnel boring machine;

a function determination unit used for determining, according to a loss function and the expression of the dimensionless factor, an objective function for predicting the specific energy;

a training sample data obtaining unit used for obtaining sample data of the parameters, influencing the specific energy, of the tunnel boring machine for model training and sample data of the parameter of the specific energy of the cutter head of the tunnel boring machine for model training;

a weight determination unit used for substituting the data sample of the parameters, influencing the specific energy, of the tunnel boring machine for model training and the data sample of the specific energy of the cutter head of the tunnel boring machine for model training into the objective function, and optimizing the objective function to obtain the weight of the dimensionless factor; and

a model determination unit used for obtaining the model for predicting the specific energy of an apparatus according to the weight and the expression of the dimensionless factor.

Preferably, the obtaining module may include:

an obtaining unit used for obtaining parameters, influencing the specific energy to be measured, of the tunnel boring machine, where the parameters influencing the specific energy to be measured may include a geological environment feature parameter, geometric structure parameters of an apparatus and a tunnel and an operation state parameter of the apparatus; where the geological environment feature parameters may include: uniaxial compressive strength of a rock, a volumetric joint count, weak plane structure spacing, an intactness coefficient of the rock, a structural plane direction, a structural plane dip angle, an included angle between a structural plane and a tunnel axis, a maximum horizontal principal stress of a tunnel, a minimum horizontal principal stress of the tunnel and a maximum initial stress perpendicular to the tunnel axis; the geometric structure parameters may include: a diameter of the cutter head of the tunnel boring machine and a tunnel burial depth; and the operation state parameters may include: a tunnel boring speed of the tunnel boring machine, a rotation speed of the cutter head, a horizontal pressure of a support cylinder and a push pressure of a shield cylinder.

Preferably, the function determination unit may include:

a substitution subunit used for substituting the expression of the dimensionless factor into the loss function; and

an objective function determination unit used for adding parameter norm penalty into the loss function with the substituted expression of the dimensionless factor, to obtain the objective function.

Based on specific embodiments provided in the present disclosure, the present disclosure has the following technical effects:

The present disclosure provides a method and system for predicting specific energy of a cutter head of a tunnel boring machine. The method includes: obtaining parameters, influencing specific energy to be measured, of the tunnel boring machine, where the parameters influencing the specific energy to be measured include a geological environment feature parameter, geometric structure parameters of an apparatus and a tunnel and an operation state parameter of the apparatus; and inputting the parameters, influencing the specific energy to be measured, of the tunnel boring machine into a model for predicting the specific energy of an apparatus, to obtain a predicted specific energy value; and calculating a proportion of a specific energy component according to the predicted value of the specific energy of the cutter head, the parameters, influencing the specific energy of the cutter head to be measured, of the tunnel boring machine, a weight and an expression of a dimensionless factor. A method for determining the model for predicting the specific energy of an apparatus includes: determining the parameters, influencing the specific energy, of the tunnel boring machine, and determining an expression of a dimensionless factor with a physical mapping relation according to the determined parameters, influencing the specific energy, of the tunnel boring machine and a parameter of the specific energy of the cutter head of the tunnel boring machine; determining, according to a loss function and the dimensionless factor, an objective function for predicting the specific energy; obtaining a data sample of parameters influencing the specific energy and a data sample of the parameter of the specific energy of the cutter head of the tunnel boring machine for model training; optimizing the objective function by using the obtained data samples to obtain a weight of the dimensionless factor; and obtaining the model for predicting the specific energy of an apparatus according to the weight and the expression of the dimensionless factor. The present disclosure may predict the total specific energy of the cutter head and may provide a proportion of each component in the total specific energy of the cutter head, thereby providing a foundation for optimal allocation of the specific energy of the cutter head of the tunnel boring machine. The present disclosure also facilitates energy conservation and consumption reduction and reduces various construction safety risks; and on the premise that dimension of two sides of the equation in the model is consistent, influence factors of geometric structures of an apparatus and a tunnel, an operation state of an apparatus, a geological environment feature, etc. are comprehensively considered, thereby improving accuracy and reliability of an estimation result.

### BRIEF DESCRIPTION OF THE DRAWINGS

In order to explain the technical solutions in embodiments of the present disclosure or in the prior art more clearly, the accompanying drawings required in the embodiments will be described below briefly. Apparently, the accompanying drawings in the following description show merely some embodiments of the present disclosure, and other drawings can be derived from these accompanying drawings by those of ordinary skill in the art without creative efforts.

FIG. 1 is a flowchart of a method in an embodiment provided in the present disclosure; and

FIG. 2 is a connection diagram of a system in an embodiment provided in the present disclosure.

### DETAILED DESCRIPTION

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. Based on the embodiments of the present disclosure, all other embodiments acquired by those of ordinary skill in the art without making creative efforts fall within the scope of protection of the present disclosure.

The objective of the present disclosure is to provide a method and system for predicting specific energy of a cutter head of a tunnel boring machine. Influence factors of geometric structures of an apparatus and a tunnel, an operation state of an apparatus, a geological environment feature, etc. are comprehensively considered, thereby providing a foundation for optimal allocation of the specific energy of the cutter head of the tunnel boring machine.

To make the foregoing objective, features, and advantages of the present disclosure clearer and more comprehensible, the present disclosure will be further described in detail below in conjunction with the accompanying drawings and specific embodiments.

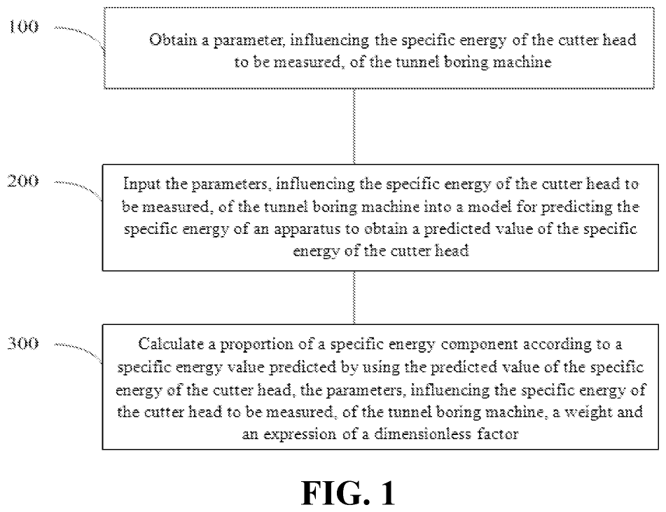

FIG. 1 is a flowchart of a method in an embodiment provided in the present disclosure. As shown in FIG. 1, a method for predicting specific energy of a cutter head of a tunnel boring machine includes:

Step 100: obtain parameters, influencing the specific energy of the cutter head to be measured, of the tunnel boring machine, where the parameters influencing the specific energy of the cutter head to be measured include a geological environment feature parameter, geometric structure parameters of an apparatus and a tunnel and an operation state parameter of the apparatus.

Step 200: input the parameters, influencing the specific energy of the cutter head to be measured, of the tunnel boring machine into a model for predicting the specific energy of an apparatus to obtain a predicted value of the specific energy of the cutter head.

Step 300: calculate a proportion of a specific energy component according to the predicted value of the specific energy of the cutter head, the parameters, influencing the specific energy of the cutter head to be measured, of the tunnel boring machine, a weight and an expression of a dimensionless factor.

A method for determining the model for predicting the specific energy of an apparatus includes:

determine the parameters, influencing the specific energy, of the tunnel boring machine and the parameter of the specific energy of the cutter head of the tunnel boring machine;

determine the expression of the dimensionless factor with a physical mapping relation according to the parameters, influencing the specific energy, of the tunnel boring machine and the parameter of the specific energy of the cutter head of the tunnel boring machine;

determine, according to a loss function and the expression of the dimensionless factor, an objective function for predicting the specific energy;

obtain a data sample of the parameters, influencing the specific energy, of the tunnel boring machine for model training and a data sample of the parameter of the specific energy of the cutter head of the tunnel boring machine for model training;

substitute the data sample of the parameters, influencing the specific energy, of the tunnel boring machine for model training and the data sample of the specific energy of the cutter head of the tunnel boring machine for model training into the objective function, and optimize the objective function to obtain the weight of the dimensionless factor; and

obtain the model for predicting the specific energy of an apparatus according to the weight and the expression of the dimensionless factor.

Preferably, the step of determining the parameters, influencing the specific energy, of the tunnel boring machine and the parameter of the specific energy of the cutter head of the tunnel boring machine includes:

determine thrust, torque and a depth of penetration of the tunnel boring machine in the data sample of the specific energy of the cutter head of the tunnel boring machine for model training; and

calculate, according to the thrust, the torque and the depth of penetration of the tunnel boring machine, the specific energy of the cutter head of the tunnel boring machine in the data sample of the specific energy of the cutter head of the tunnel boring machine for model training

Specifically, the specific energy of the cutter head is calculated according to:

E_{c}=2πT+Fp;

where E_{c} is the specific energy of the cutter head, F is total tunnel boring thrust, T is total tunnel boring torque, and p is the depth of penetration of the tunnel boring machine.

Preferably, the parameters influencing the specific energy include: a) geological environment feature parameters: uniaxial compressive strength σ_{c} of the rock, a volumetric joint count Jᵥ, weak plane structure spacing DPW, an intactness coefficient Kᵥ of the rock, a structural plane direction α₁, a structural plane dip angle α₂, an included angle α₃ between a structural plane and a tunnel axis, a maximum horizontal principal stress σₕ₁ of a tunnel, a minimum horizontal principal stress σₕ₂ of the tunnel and a maximum initial stress σ₀ perpendicular to the tunnel axis; b) geometric structure parameters of an apparatus and a tunnel: a diameter D of the cutter head of the apparatus and a tunnel burial depth H; and c) parameters related to the operation state of the apparatus: a tunnel boring speed v, a rotation speed w of the cutter head of the apparatus, a horizontal pressure p_{cH} of a support cylinder and a push pressure P_{cT} of a shield cylinder of the apparatus.

Preferably, the step of determining the expression of the dimensionless factor with a physical mapping relation according to the parameters, influencing the specific energy, of the tunnel boring machine and the parameter of the specific energy of the cutter head of the tunnel boring machine includes:

calculate an expression of a first factor according to the tunnel burial depth and the diameter of the cutter head;

calculate an expression of a second factor according to the tunnel boring speed, the diameter of the cutter head and the rotation speed of the cutter head;

calculate an expression of a specific energy factor according to the specific energy of the cutter head, the uniaxial compressive strength of the rock, the diameter of the cutter head and a calculated second factor;

calculate an expression of a third factor according to the volumetric joint count and the diameter of the cutter head;

calculate an expression of a fourth factor according to the weak plane structure spacing and the diameter of the cutter head;

calculate an expression of a fifth factor according to the intactness coefficient of the rock;

calculate an expression of a sixth factor according to the structural plane direction;

calculate an expression of a seventh factor according to the structural plane dip angle;

calculate an expression of an eighth factor according to the included angle between the structural plane and the tunnel axis;

calculate an expression of a ninth factor according to the maximum horizontal principal stress of the tunnel and the uniaxial compressive strength of the rock;

calculate an expression of a tenth factor according to the minimum horizontal principal stress of the tunnel and the uniaxial compressive strength of the rock;

calculate an expression of an eleventh factor according to the maximum initial stress perpendicular to the tunnel axis and the uniaxial compressive strength of the rock;

calculate an expression of a twelfth factor according to the horizontal pressure of the support cylinder and the uniaxial compressive strength of the rock;

calculate an expression of a thirteenth factor according to the push pressure of the shield cylinder and the uniaxial compressive strength of the rock; and

the expressions of the dimensionless factor include the expression of the specific energy factor, the expression of the first factor, the expression of the second factor, the expression of the third factor, the expression of the fourth factor, the expression of the fifth factor, the expression of the sixth factor, the expression of the seventh factor, the expression of the eighth factor, the expression of the ninth factor, the expression of the tenth factor, the expression of the eleventh factor, the expression of the twelfth factor, and the expression of the thirteenth factor.

Specifically, thirteen dimensionless factors π are provided: π₁˜π₁₃, and the dimensionless specific energy value π₀ of the tunnel boring machine is provided. The dimensionless factor π is a dimensionless factor with a physical mapping relation after original features are combined and transformed. A calculation formula for the dimensionless factor and its physical meaning are shown in Table 1:

TABLE 1

| Dimensionless | Calculation | |
|---|---|---|
| factor | formula | Physical meaning |
| π₁ | HD⁻¹ | A dimensionless tunnel burial depth H, that is, a |
| | | tunnel burial depth ratio |
| π₂ | vD⁻¹w⁻¹ | A dimensionless depth, penetrating into rock, of a |
| | | cutter, that is, a dimensionless penetration degree p. |
| π₃~π₅ | JᵥD³ | A dimensionless development degree of a rock |
| | DPW · D | fracture, considering a volumetric joint count Jᵥ, |
| | Kᵥ | weak plane spacing DPWand an intactness |
| | | coefficient Kᵥ of the rock |
| π₆~π₈ | α₁-α₃ | A growth direction α₁-α₃ of the rock fracture. |
| π₉~π₁₁ | σₕ₁σ_{c}⁻¹ | Dimensionless strength of internal force of |
| | σₕ₂σ_{c}⁻¹ | surrounding rock of unit plane, considering |
| | σ₀σ_{c}⁻¹ | horizontal σₕ₁, σₕ₂ and vertical directions σ₀ |
| π₁₂~π₁₃ | p_{cH}σ_{c}⁻¹ | A dimensionless contact feature of an apparatus and |
| | p_{cT}σ_{c}⁻¹ | a tunnel wall, considering pressures of a support |
| | | cylinder p_{cH} and a shield cylinder p_{cT}. |
| π₀ | E_{c}σ_{c}⁻¹D⁻³ | Dimensionless specific energy E_{c} of a cutter head. |

In the calculation formula of the Table 1: H is the tunnel burial depth; D is the diameter of the cutter head of the apparatus; v is the tunnel boring speed; w is the rotation speed of cutter head of the apparatus; Jᵥ is a volumetric joint count; DPW is the weak plane structure spacing; Kᵥ is the intactness coefficient of the rock; α₁ is a structural plane direction; α₂ is a structural plane dip angle; α₃ is the included angle between a structural plane and a tunnel axis; σₕ₁ is the maximum horizontal principal stress of the tunnel; σₕ₂ is the minimum horizontal principal stress of the tunnel; σ₀ is the maximum initial stress perpendicular to the tunnel axis; σ_{c} is the uniaxial compressive strength of the rock; p_{cH} is the horizontal pressure of the support cylinder of the apparatus; p_{cT} is the push pressure of the shield cylinder; and E_{c} is the specific energy of the cutter head.

Specifically, after obtaining Table 1, the obtained objective quantity π₀=E_{c}σ_{c}⁻¹D⁻³ is transformed as follows:

π₀′=π₀/π₂=E_{c}σ_{c}⁻¹p⁻¹D⁻²

where π₀′ is a final specific energy factor.

Preferably, the step of determining, according to a loss function and the expression of the dimensionless factor, an objective function for predicting the specific energy includes:

substitute the expression of the dimensionless factor into the loss function;

add parameter norm penalty into the loss function with the substituted expression of the dimensionless factor, to obtain the objective function.

Specifically, the obtained physical mapping relation is substituted into the loss function to obtain a loss function incorporating physical knowledge as:

$$L = \frac{1}{n} {\sum }_{j = 1}^{n} {( {\sum }_{i = 1}^{13} {θ}_{i} {π}_{ij} - {π}_{0 j}^{′} )}^{2} .$$

In the formula, L represents the loss function, n is the number of training samples, i may be taken from 1-13, πᵢⱼ represents a value of πᵢ obtained from the jth sample, θᵢ, represents a coefficient of the ith factor π, πᵢ, and π₀ⱼ′; represents a value of π₀ obtained from the jth sample.

Optionally, an L₁ norm penalty term is added on the basis of the loss function to obtain the objective function, with the physical knowledge embedded, for predicting the specific energy:

$$J ( θ ) = \frac{1}{2 n} {\sum }_{j = 1}^{n} {( {\sum }_{j = 1}^{13} {θ}_{i} {π}_{ij} - {π}_{0 j}^{′} )}^{2} + λ {\sum }_{j = 1}^{13} \vert {θ}_{i} \vert .$$

The left J(θ) of the equation represents the objective function for predicting the specific energy, and a first term on the right of the equation is the loss function divided by 2, λ represents a penalty degree of a regularization penalty term, and θᵢ represents a coefficient of the ith factor π, πᵢ.

Preferably, the step of optimizing the objective function to obtain the weight of the dimensionless factor includes:

select, according to a parameter debugging result, a hyper-parameter value with a minimum objective function value to be as a value of a hyper-parameter in the objective function; and substitute the optimized hyper-parameter into the objective function, and optimize the objective function according to the data sample of the parameters, influencing the specific energy, of the tunnel boring machine and the data sample of the specific energy of the cutter head for model training, to obtain the weight of the dimensionless factor.

Specifically, firstly, different values are taken for the hyper-parameter λ, and prediction effects of λ with the different values are tested on a training set, that is, the parameter λ* which minimizes the value of the objective function optimized by the coordinate descent method is taken as the value of λ in the final objective function. The coordinate descent method is used again, all samples of the training set are used to optimize the objective function, and the optimal weight θᵢ* corresponding to each factor π is obtained via calculation.

Existing research only simply uses a machine learning method to predict the specific energy of the tunnel boring machine. Although the method may provide a predicted value of total specific energy, used models all are an input-output black box model, and the method may not provide a traceable physical mechanism, that is, may not provide a contribution rate of each component of the specific energy changing during a construction process in real time. It is obviously insufficient for the intelligent operation requirement of an engineering apparatus with high safety risk, and this defect is not beneficial to optimize and control the specific energy of the tunnel boring machine in practical application. Therefore, on the premise of guaranteeing accuracy of the model, a traceable function for predicting the specific energy of the tunnel boring machine is needed, and the technical solution achieves the function by calculating the proportion of the specific energy component according to the predicted specific energy value, the parameters, influencing the specific energy, of the tunnel boring machine to be measured, the weight and the dimensionless factor.

Preferably, the proportion of the specific energy component is calculated according to:

$${P}_{i} = \frac{{σ}_{c} v {w}^{- 1} {D}^{2} \cdot {θ}_{i}^{*} \cdot {π}_{i}}{{E}_{c}^{*}} ;$$

where Pᵢ is a proportion of an ith component in calculated total specific energy; σ_{c} is the geological environment feature parameter; vw⁻¹ is the operation state parameter; θᵢ* is the weight; πᵢ is the ith dimensionless factor; and E_{c}* is a prediction result of the total specific energy of the tunnel boring machine.

In this embodiment, the parameters and specific values of the specific energy of the training set are first collected, as shown in Table 2.

TABLE 2

| F (kN) | T (kN · m) | p (m/r) |
|---|---|---|
| 16037.82 | 4655.422 | 0.007117 |
| 13746.7 | 4225.089 | 0.007796 |
| 14663.15 | 4433.735 | 0.007608 |
| 16954.27 | 5547.041 | 0.007282 |
| 17870.71 | 4784.143 | 0.005938 |
| 17870.71 | 4612.236 | 0.006885 |
| 17412.49 | 5253.976 | 0.008283 |
| 17870.71 | 3245.891 | 0.006264 |
| 17870.71 | 4604.263 | 0.00708 |
| 16954.27 | 3163.091 | 0.005657 |

F is total tunnel boring thrust, T is total tunnel boring torque, and p is the depth of penetration of the tunnel boring machine.

The total specific energy of each sample in the training set is calculated: E_{c}=2πT+Fp. Results of the calculations are summarized as shown in Table 3.

TABLE 3
E_{c} (kJ)
29365.024
26654.182
27969.539
34976.545
30165.769
29102.567
33155.934
20506.474
29055.956
19970.196

The main parameters and specific values influencing the specific energy of the tunnel boring machine in the training set are listed as shown in Table 4-1 and Table 4-2.

TABLE 4-1

| D(m) | v(m/s) | w(r/s) | H(m) | σ_{c}(kpa) | Jᵥ(m⁻³) | DPW(m⁻¹) | Kᵥ |
|---|---|---|---|---|---|---|---|
| 8.03 | 0.0009 | 0.1245 | 331 | 54000 | 8.95 | 0.3 | 0.58 |
| 8.03 | 0.0009 | 0.1176 | 148 | 48000 | 6.5 | 0.8 | 0.65 |
| 8.03 | 0.0009 | 0.1245 | 67 | 54000 | 12 | 0.2 | 0.51 |
| 8.03 | 0.0009 | 0.1259 | 202.5 | 57000 | 5.45 | 0.9 | 0.68 |
| 8.03 | 0.0008 | 0.1287 | 298 | 66000 | 6.5 | 0.8 | 0.65 |
| 8.03 | 0.0007 | 0.1065 | 309.5 | 64000 | 4.75 | 1.8 | 0.7 |
| 8.03 | 0.0007 | 0.083 | 383.5 | 48000 | 3.7 | 1.2 | 0.73 |
| 8.03 | 0.0006 | 0.0927 | 389 | 67000 | 4.75 | 1.5 | 0.7 |
| 8.03 | 0.0008 | 0.1079 | 250.5 | 61000 | 4.05 | 1.7 | 0.72 |
| 8.03 | 0.0006 | 0.1134 | 102 | 58000 | 4.05 | 1.2 | 0.72 |

TABLE 4-2

| α₁(rad) | α₂(rad) | α₃(rad) | σₕ₁(kpa) | σₕ₂(kpa) | σ₀(kpa) | p_{cH}(kpa) | p_{cT}(kpa) |
|---|---|---|---|---|---|---|---|
| 5.0615 | 0.384 | 0.384 | 14896 | 9250.8 | 11778 | 32405 | 6894.8 |
| 5.8469 | 1.3614 | 0.4014 | 8138.1 | 5570.7 | 6720.2 | 31026 | 6894.8 |
| 5.0615 | 1.2741 | 0.384 | 5762.2 | 3555.7 | 4543.6 | 32405 | 6894.8 |
| 5.0615 | 1.2566 | 0.384 | 10286 | 6590.5 | 8245.3 | 32405 | 6894.8 |
| 5.4105 | 1.309 | 0.0349 | 13330 | 8819.4 | 10839 | 32405 | 6894.8 |
| 5.4105 | 1.3614 | 0.0349 | 13341 | 9317.5 | 11119 | 32405 | 6894.8 |
| 5.4454 | 0.7854 | 0 | 16770 | 10348 | 13223 | 32405 | 6894.8 |
| 5.4105 | 0.8378 | 0.0349 | 17408 | 10167 | 13409 | 30337 | 6894.8 |
| 5.4978 | 1.4312 | 0.0524 | 12267 | 7429.3 | 9595.2 | 30337 | 6894.8 |
| 5.4105 | 1.4835 | 0.0349 | 6538.6 | 4576.4 | 5454.9 | 29647 | 6894.8 |

In the above tables: H is the tunnel burial depth; D is the diameter of the cutter head of the apparatus; v is the tunnel boring speed; w is the rotation speed of cutter head of the apparatus; Jᵥ is a volumetric joint count; DPW is the weak plane structure spacing; Kᵥ is the intactness coefficient of the rock; α₁ is a structural plane direction; α₂ is a structural plane dip angle; α₃ is the included angle between a structural plane and a tunnel axis; σₕ₁ is the maximum horizontal principal stress of the tunnel; σₕ₂ is the minimum horizontal principal stress of the tunnel; σ₀ is the maximum initial stress perpendicular to the tunnel axis; σ_{c} is the uniaxial compressive strength of the rock; p_{cH} is the horizontal pressure of the support cylinder of the apparatus; p_{cT} is the push pressure of the shield cylinder; and E_{c} is the specific energy of the cutter head.

The factor π π₁˜π₁₃ with the physical mapping relation is calculated. The calculation formula is shown in Table 5:

TABLE 5

| factor π | Calculation formula | | |
|---|---|---|---|
| π₁ | | HD⁻¹ | |
| π₂ | | vD⁻¹w⁻¹ | |
| π₃~π₅ | JᵥD³ | DPW · D | Kᵥ |
| π₆~π₈ | | α₁-α₃ | |
| π₉~π₁₁ | σₕ₁σ_{c}⁻¹ | σₕ₂σ_{c}⁻¹ | σ₀σ_{c}⁻¹ |
| π₁₂~π₁₃ | p_{cH}σ_{c}⁻¹ | | p_{cT}σ_{c}⁻¹ |
| π₀ | | E_{c}σ_{c}⁻¹D⁻³ | |

The obtained objective quantity π₀=E_{c}σ_{c}⁻¹D⁻³ is transformed as follows:

π₀′=π₀/π₂=E_{c}σ_{c}⁻¹p⁻¹D⁻².

The calculated thirteen factors π and the calculated values of π₀′ are summarized as shown in Tables 6 and 7.

TABLE 6

| π₁ | π₂ | π₃ | π₄ | π₅ | π₆ | π₇ | π₈ |
|---|---|---|---|---|---|---|---|
| 41.22042 | 0.000886 | 4634.146 | 2.409 | 0.58 | 5.061 | 0.384 | 0.384 |
| 18.43088 | 0.000971 | 3365.581 | 6.424 | 0.65 | 5.847 | 1.361 | 0.4014 |
| 8.343711 | 0.000947 | 6213.38 | 1.606 | 0.51 | 5.061 | 1.274 | 0.384 |
| 25.21793 | 0.000907 | 2821.91 | 7.227 | 0.68 | 5.061 | 1.257 | 0.384 |
| 37.11083 | 0.000739 | 3365.581 | 6.424 | 0.65 | 5.411 | 1.309 | 0.0349 |
| 38.54296 | 0.000857 | 2459.463 | 14.454 | 0.7 | 5.411 | 1.361 | 0.0349 |
| 47.75841 | 0.001032 | 1915.792 | 9.636 | 0.73 | 5.445 | 0.785 | 0 |
| 48.44334 | 0.00078 | 2459.463 | 12.045 | 0.7 | 5.411 | 0.838 | 0.0349 |
| 31.19552 | 0.000882 | 2097.016 | 13.651 | 0.72 | 5.498 | 1.431 | 0.0524 |
| 12.70237 | 0.000704 | 2097.016 | 9.636 | 0.72 | 5.411 | 1.484 | 0.0349 |

TABLE 7

| π₉ | π₁₀ | π₁₁ | π₁₂ | π₁₃ | π₀ |
|---|---|---|---|---|---|
| 0.275847 | 0.171311 | 0.218115 | 0.600099 | 0.127681 | 1.184914 |
| 0.169544 | 0.116057 | 0.140005 | 0.646383 | 0.143641 | 1.104657 |
| 0.106707 | 0.065847 | 0.084141 | 0.600099 | 0.127681 | 1.055791 |
| 0.180463 | 0.115623 | 0.144654 | 0.568515 | 0.120961 | 1.306856 |
| 0.201965 | 0.133627 | 0.164224 | 0.49099 | 0.104466 | 1.193765 |
| 0.208455 | 0.145587 | 0.173735 | 0.506334 | 0.107731 | 1.024322 |
| 0.349365 | 0.215581 | 0.275481 | 0.675112 | 0.143641 | 1.293285 |
| 0.259816 | 0.151741 | 0.20013 | 0.45279 | 0.102907 | 0.75778 |
| 0.201096 | 0.121791 | 0.157299 | 0.497327 | 0.113029 | 1.043435 |
| 0.112734 | 0.078904 | 0.094051 | 0.511163 | 0.118875 | 0.943962 |

The physical mapping relation obtained in the last step is substituted into the loss function to obtain a loss function incorporating physical knowledge as:

$$L = \frac{1}{n} {\sum }_{j = 1}^{10} {( {\sum }_{i = 1}^{13} {θ}_{i} {π}_{ij} - {π}_{0 j}^{′} )}^{2} .$$

In the formula, L represents the loss function, i represents the ith factor π, j represents the jth sample, πᵢⱼ represents a value of πᵢ obtained from the jth sample, θᵢ represents a coefficient of the ith factor π, πᵢ, and π₀ⱼ′ represents a value of π₀ obtained from the jth sample.

An L₁ norm penalty term is added on the basis of the loss function to obtain the objective function, with the physical knowledge embedded, for predicting the specific energy:

$$J ( θ ) = \frac{1}{2 n} {\sum }_{j = 1}^{10} {( {\sum }_{i = 1}^{13} {θ}_{i} {π}_{ij} - {π}_{0 j}^{′} )}^{2} + λ {\sum }_{i = 1}^{13} \vert {θ}_{i} \vert$$

The left J(θ) of the equation represents the objective function for predicting the specific energy, and a first term on the right of the equation is the loss function divided by 2, λ represents a penalty degree of a regularization penalty term, and θᵢ represents a coefficient of the ith factor π, πᵢ.

Firstly, different values are taken for the hyper-parameter λ, and prediction effects of λ with the different values are tested on a training set, that is, the parameter λ* which minimizes the value of the objective function optimized by the coordinate descent method is taken as the value of λ in the final objective function. The final result of the hyper-parameter λ selection is: λ*=0.00149354. The coordinate descent method is used again, all samples of the training set are used to optimize the objective function, the optimal weight θᵢ* corresponding to each factor π is obtained via calculation, and calculated optimal weights are summarized as shown in Table 8.

TABLE 8

| | |
|---|---|
| θ*₁ | 0.005478 |
| θ*₂ | 0 |
| θ*₃ | 0.000003849 |
| θ*₄ | 0 |
| θ*₅ | 0 |
| θ*₆ | 0 |
| θ*₇ | 0.1551 |
| θ*₈ | 0.2225 |
| θ*₉ | 0 |
| θ*₁₀ | 0 |
| θ*₁₁ | 0 |
| θ*₁₂ | 1.2476 |
| θ*₁₃ | 0 |

Above coefficient identification results θᵢ* are separately multiplied by the corresponding factors π to obtain a model for predicting the specific energy of the tunnel boring machine as follows:

E_{c}*=(5.48×10−3HD⁻¹+3.85×10⁻⁶JᵥD³+1.55×10⁻¹α₂+2.22×10⁻¹α₃+1.25p_{cH}σ_{c}⁻¹)σ_{c}vw⁻¹D²

Tables 9 and 10 show engineering data, and the total specific energy E_{c}* of the tunnel boring machine may be obtained by substituting the data of Tables 9 and 10 into the prediction model, and Tables 9 and 10 are shown below where E_{c}*:=22614.55987 kJ.

TABLE 9

| D(m) | v(m/s) | w(r/s) | H(m) | σ_{c}(kpa) | Jᵥ(m⁻³) | DPW(m⁻¹) | Kᵥ |
|---|---|---|---|---|---|---|---|
| 8.03 | 0.0008 | 0.1245 | 69.5 | 69000 | 4.05 | 1.6 | 0.72 |

TABLE 10

| α₁(rad) | α₂(rad) | α₃(rad) | σₕ₁(kpa) | σₕ₂(kpa) | σ₀(kpa) | p_{cH}(kpa) | p_{cT}(kpa) |
|---|---|---|---|---|---|---|---|
| 5.4105 | 1.3963 | 0.0349 | 8780 | 5181 | 6792 | 30337 | 6894.8 |

The obtained model for predicting the specific energy of the tunnel boring machine is used to separately calculate the proportion of different specific energy components:

$${P}_{i} = \frac{{σ}_{c} v {w}^{- 1} {D}^{2} \cdot {θ}_{i}^{*} \cdot {π}_{i}}{{E}_{c}^{*}} .$$

Pi represents the proportion of the ith component in the calculated total specific energy. The obtained proportions of the specific energy components with each term being non-zero are represented in Table 11.

TABLE 11

| P₁ | P₃ | P₇ | P₈ | P₁₂ |
|---|---|---|---|---|
| 0.0572376 | 0.0097436 | 0.2614936 | 0.0093745 | 0.6621507 |

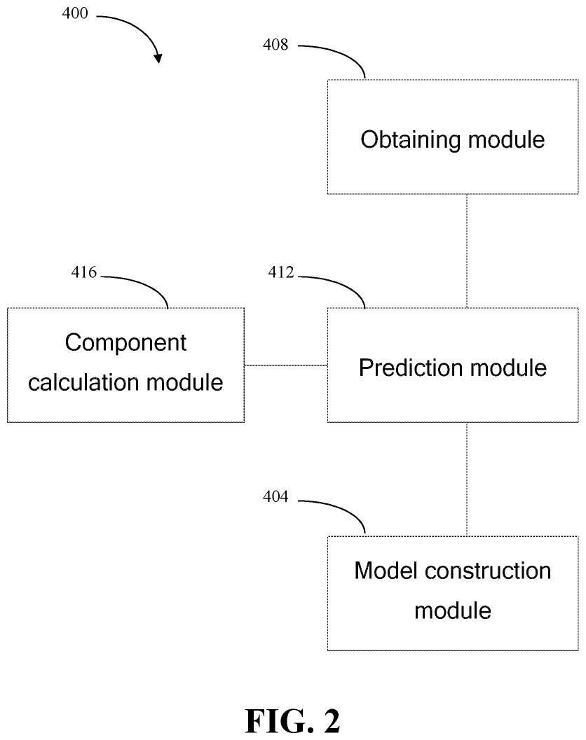

FIG. 2 is a connection diagram of a system 400 in an embodiment provided in the present disclosure. As shown in FIG. 2, the system 400 for predicting specific energy of a cutter head of a tunnel boring machine includes:

a model construction module 404 used for determining a model for predicting the specific energy of an apparatus;

an obtaining module 408 used for obtaining parameters influencing the specific energy of the cutter head to be measured, where the parameters influencing the specific energy of the cutter head to be measured include a geological environment feature parameter, geometric structure parameters of the apparatus and a tunnel and an operation state parameter of the apparatus;

a prediction module 412 used for inputting the parameters, influencing the specific energy to be measured, of the tunnel boring machine into the model for predicting the specific energy of an apparatus, to obtain a predicted specific energy value; and

a component calculation module 416 used for calculating a proportion of a specific energy component according to the predicted value of the specific energy of the cutter head, the parameters, influencing the specific energy of the cutter head to be measured, of the tunnel boring machine, a weight and an expression of a dimensionless factor;

where the model construction module 404 specifically includes:

a determination unit used for determining the parameters, influencing the specific energy, of the tunnel boring machine and the parameter of the specific energy of the cutter head of the tunnel boring machine;

a physical relation calculation unit used for determining the expression of the dimensionless factor with a physical mapping relation according to the parameters, influencing the specific energy, of the tunnel boring machine and the parameter of the specific energy of the cutter head of the tunnel boring machine;

a function determination unit used for determining, according to a loss function and the expression of the dimensionless factor, an objective function for predicting the specific energy;

a training sample data obtaining unit used for obtaining sample data of the parameters, influencing the specific energy, of the tunnel boring machine for model training and sample data of the parameter of the specific energy of the cutter head of the tunnel boring machine for model training;

a weight determination unit used for substituting the data sample of the parameters, influencing the specific energy, of the tunnel boring machine for model training and the data sample of the specific energy of the cutter head of the tunnel boring machine for model training into the objective function, and optimizing the objective function to obtain the weight of the dimensionless factor; and

a model determination unit used for obtaining the model for predicting the specific energy of an apparatus according to the weight and the expression of the dimensionless factor.

Preferably, the obtaining module 408 includes:

an obtaining unit used for obtaining parameters, influencing the specific energy to be measured, of the tunnel boring machine, where the parameters influencing the specific energy to be measured include a geological environment feature parameter, geometric structure parameters of an apparatus and a tunnel and an operation state parameter of the apparatus; where the geological environment feature parameters include: uniaxial compressive strength of a rock, a volumetric joint count, weak plane structure spacing, an intactness coefficient of the rock, a structural plane direction, a structural plane dip angle, an included angle between a structural plane and a tunnel axis, a maximum horizontal principal stress of a tunnel, a minimum horizontal principal stress of the tunnel and a maximum initial stress perpendicular to the tunnel axis; the geometric structure parameters include: a diameter of the cutter head of the tunnel boring machine and a tunnel burial depth; and the operation state parameters include: a tunnel boring speed of the tunnel boring machine, a rotation speed of the cutter head, a horizontal pressure of a support cylinder and a push pressure of a shield cylinder.

Preferably, the function determination unit includes:

a substitution subunit used for substituting the expression of the dimensionless factor into the loss function; and

an objective function determination unit used for adding parameter norm penalty into the loss function with the substituted expression of the dimensionless factor, to obtain the objective function.

The present disclosure has the following beneficial effects:

(1) The present disclosure may predict total specific energy so as to facilitate energy conservation and consumption reduction and reduce various construction safety risks. On the premise that dimension of two sides of the equation in the model is consistent, influence factors of geometric structures of an apparatus and a tunnel, an operation state of an apparatus, a geological environment feature, etc. are comprehensively considered, so estimation is accurate and reliable.

(2) The present disclosure provides a contribution rate of each specific energy component changing during a construction process in real time, and it is well-founded to trace and allocate the specific energy of a control system of the tunnel boring machine.

Each example of the present specification is described in a progressive manner, each example focuses on the difference from other examples, and the same and similar parts between the examples may refer to each other. Since the system disclosed in the embodiments corresponds to the method disclosed in the embodiments, the description is simple, and reference can be made to the method description.

In this specification, several specific embodiments are used for illustration of the principles and implementations of the present disclosure. The description of the foregoing embodiments is used to help illustrate the method of the present disclosure and the core ideas thereof. In addition, those of ordinary skill in the art can make various modifications in terms of specific implementations and the scope of application in accordance with the ideas of the present disclosure. In conclusion, the content of this specification shall not be construed as a limitation to the present disclosure.

What is claimed is:

1. A method for predicting a specific energy of a cutter head of a tunnel boring machine, comprising:
obtaining parameters of the tunnel boring machine configured to influence the specific energy of the cutter head to be measured, wherein the obtained parameters comprise (i) a geological environment feature parameter, (ii) geometric structure parameters of an apparatus and a tunnel, and (iii) an operation state parameter of the apparatus;
inputting the obtained parameters of the tunnel boring machine into a model configured to predict a specific energy of the apparatus to obtain a predicted value of the specific energy of the cutter head; and
calculating a proportion of a specific energy component according to the predicted value of the specific energy of the cutter head, the obtained parameters of the tunnel boring machine, and a weight and an expression of a dimensionless factor;
wherein determining the model configured to predict the specific energy of the apparatus comprises:
determining the obtained parameters of the tunnel boring machine and a parameter of the specific energy of the cutter head of the tunnel boring machine;
determining the expression of the dimensionless factor with a physical mapping relation according to the obtained parameters of the tunnel boring machine and the parameter of the specific energy of the cutter head of the tunnel boring machine;
determining, according to a loss function and the expression of the dimensionless factor, an objective function configured to predict the specific energy of the cutter head of the tunnel boring machine;
obtaining (i) a data sample of the obtained parameters of the tunnel boring machine for model training, and (ii) a data sample of the parameter of the specific energy of the cutter head of the tunnel boring machine for model training;
substituting the data sample of the obtained parameters of the tunnel boring machine for model training and the data sample of the parameter of the specific energy of the cutter head of the tunnel boring machine for model training into the objective function, and optimizing the objective function to obtain the weight of the dimensionless factor; and
determining the model configured to predict the specific energy of the apparatus according to the weight and the expression of the dimensionless factor.

2. The method for predicting the specific energy of the cutter head of the tunnel boring machine according to claim 1, wherein determining the obtained parameters of the tunnel boring machine and the parameter of the specific energy of the cutter head of the tunnel boring machine comprises:
determining a thrust, a torque, and a depth of penetration of the tunnel boring machine in the data sample of the parameter of the specific energy of the cutter head of the tunnel boring machine for model training; and
calculating, according to the thrust, the torque, and the depth, the specific energy of the cutter head of the tunnel boring machine in the data sample of the parameter of the specific energy of the cutter head of the tunnel boring machine for model training.

3. The method for predicting the specific energy of the cutter head of the tunnel boring machine according to claim 1, wherein:
the geological environment feature parameter comprises:
a uniaxial compressive strength of a rock,
a volumetric joint count,
a weak plane structure spacing,
an intactness coefficient of the rock,
a structural plane direction of a structural plane,
a structural plane dip angle of the structural plane,
an included angle between the structural plane and a tunnel axis of the tunnel,
a maximum horizontal principal stress of the tunnel,
a minimum horizontal principal stress of the tunnel, and
a maximum initial stress perpendicular to the tunnel axis;
the geometric structure parameters comprise:
a diameter of the cutter head of the tunnel boring machine, and
a tunnel burial depth; and
the operation state parameters comprise:
a tunnel boring speed of the tunnel boring machine,
a rotation speed of the cutter head,
a horizontal pressure of a support cylinder, and
a push pressure of a shield cylinder.

4. The method for predicting the specific energy of the cutter head of the tunnel boring machine according to claim 1, wherein:
determining the expression of the dimensionless factor with the physical mapping relation according to the obtained parameters of the tunnel boring machine and the parameter of the specific energy of the cutter head of the tunnel boring machine comprises:
calculating an expression of a first factor according to a tunnel burial depth and a diameter of the cutter head;
calculating an expression of a second factor according to a tunnel boring speed, the diameter of the cutter head, and a rotation speed of the cutter head;
calculating an expression of a specific energy factor according to the specific energy of the cutter head, a uniaxial compressive strength of a rock, the diameter of the cutter head, and the calculated expression of the second factor;
calculating an expression of a third factor according to a volumetric joint count and the diameter of the cutter head;
calculating an expression of a fourth factor according to a weak plane structure spacing and the diameter of the cutter head;
calculating an expression of a fifth factor according to an intactness coefficient of the rock;
calculating an expression of a sixth factor according to a structural plane direction of a structural plane;
calculating an expression of a seventh factor according to a structural plane dip angle of the structural plane;
calculating an expression of an eighth factor according to an included angle between the structural plane and a tunnel axis;
calculating an expression of a ninth factor according to a maximum horizontal principal stress of the tunnel and the uniaxial compressive strength of the rock;
calculating an expression of a tenth factor according to a minimum horizontal principal stress of the tunnel and the uniaxial compressive strength of the rock;
calculating an expression of an eleventh factor according to a maximum initial stress perpendicular to the tunnel axis and the uniaxial compressive strength of the rock;
calculating an expression of a twelfth factor according to a horizontal pressure of a support cylinder and the uniaxial compressive strength of the rock; and
calculating an expression of a thirteenth factor according to a push pressure of a shield cylinder and the uniaxial compressive strength of the rock; and
the expression of the dimensionless factor comprises the expression of the specific energy factor, the expression of the first factor, the expression of the second factor, the expression of the third factor, the expression of the fourth factor, the expression of the fifth factor, the expression of the sixth factor, the expression of the seventh factor, the expression of the eighth factor, the expression of the ninth factor, the expression of the tenth factor, the expression of the eleventh factor, the expression of the twelfth factor, and the expression of the thirteenth factor.

5. The method for predicting the specific energy of the cutter head of the tunnel boring machine according to claim 1, wherein determining, according to the loss function and the expression of the dimensionless factor, the objective function configured to predict the specific energy of the cutter head of the tunnel boring machine comprises:
substituting the expression of the dimensionless factor into the loss function; and
adding a parameter norm penalty into the loss function with the substituted expression of the dimensionless factor, to obtain the objective function.

6. The method for predicting the specific energy of the cutter head of the tunnel boring machine according to claim 1, wherein optimizing the objective function to obtain the weight of the dimensionless factor comprises:
determining a value of a hyper-parameter in the objective function according to a parameter debugging result in the data sample of the obtained parameters of the tunnel boring machine for model training and the data sample of the of the parameter of the specific energy of the cutter head of the tunnel boring machine for model training; and
substituting the value of the hyper-parameter into the objective function, and optimizing the objective function according to the data sample of the obtained parameters of the tunnel boring machine for model training and the data sample of the parameter of the specific energy of the cutter head of the tunnel boring machine for model training, to obtain the weight of the dimensionless factor.

7. The method for predicting the specific energy of the cutter head of the tunnel boring machine according to claim 1, wherein:
the proportion of the specific energy component is calculated according to:
$${P}_{i} = \frac{{σ}_{c} v {w}^{- 1} {D}^{2} \cdot {θ}_{i}^{*} \cdot {π}_{i}}{{E}_{c}^{*}} ;$$
Pᵢ is a proportion of an ith component in calculated total specific energy;
σ_{c} is the geological environment feature parameter;
vw⁻¹ is the operation state parameter;
θᵢ* is the weight of the dimensionless factor;
πᵢ is an expression of an ith dimensionless factor; and
E_{c}* is a prediction result of a total specific energy of the cutter head of the tunnel boring machine corresponding to the predicted value of the specific energy of the cutter head.

8. A system for predicting a specific energy of a cutter head of a tunnel boring machine, comprising:
a model construction module configured to determine a model for predicting a specific energy of an apparatus;
an obtaining module configured to obtain parameters of the tunnel boring machine that influence the specific energy of the cutter head to be measured, the obtained parameters comprising (i) a geological environment feature parameter, (ii) geometric structure parameters of the apparatus and a tunnel, and (iii) an operation state parameter of the apparatus;
a prediction module configured to input the obtained parameters of the tunnel boring machine into the model for predicting the specific energy of the apparatus, to obtain a predicted specific energy value of the cutter head; and
a component calculation module configured to calculate a proportion of a specific energy component according to the predicted value of the specific energy of the cutter head, the obtained parameters of the tunnel boring machine, and a weight and an expression of a dimensionless factor;
wherein the model construction module comprises:
a determination unit configured to determine the obtained parameters of the tunnel boring machine and the parameter of the specific energy of the cutter head of the tunnel boring machine;
a physical relation calculation unit configured to determine the expression of the dimensionless factor with a physical mapping relation according to the obtained parameters of the tunnel boring machine and the parameter of the specific energy of the cutter head of the tunnel boring machine;
a function determination unit configured to determine, according to a loss function and the expression of the dimensionless factor, an objective function for predicting the specific energy of the cutter head of the tunnel boring machine;
a training sample data obtaining unit configured to obtain (i) a data sample of the obtained parameters of the tunnel boring machine for model training, and (ii) a data sample of the parameter of the specific energy of the cutter head of the tunnel boring machine for model training;
a weight determination unit configured to substitute the data sample of the obtained parameters of the tunnel boring machine for model training and the data sample of the specific energy of the cutter head of the tunnel boring machine for model training into the objective function, and further configured to optimize the objective function to obtain the weight of the dimensionless factor; and
a model determination unit configured to obtain the model for predicting the specific energy of the apparatus according to the weight and the expression of the dimensionless factor.

9. The system for predicting the specific energy of the cutter head of the tunnel boring machine according to claim 8, wherein the obtaining module comprises:
an obtaining unit configured to obtain the parameters of the tunnel boring machine,
wherein the geological environment feature parameter comprises:
a uniaxial compressive strength of a rock,
a volumetric joint count,
a weak plane structure spacing,
an intactness coefficient of the rock,
a structural plane direction of a structural plane,
a structural plane dip angle of the structural plane,
an included angle between the structural plane and a tunnel axis of the tunnel,
a maximum horizontal principal stress of the tunnel,
a minimum horizontal principal stress of the tunnel, and
a maximum initial stress perpendicular to the tunnel axis;
wherein the geometric structure parameters comprise:
a diameter of the cutter head of the tunnel boring machine, and
a tunnel burial depth; and
wherein the operation state parameters comprise:
a tunnel boring speed of the tunnel boring machine,
a rotation speed of the cutter head,
a horizontal pressure of a support cylinder, and
a push pressure of a shield cylinder.

10. The system for predicting the specific energy of the cutter head of the tunnel boring machine according to claim 8, wherein the function determination unit comprises:
a substitution subunit configured to substitute the expression of the dimensionless factor into the loss function; and
an objective function determination unit configured to add a parameter norm penalty into the loss function with the substituted expression of the dimensionless factor, to obtain the objective function.
